(19) United States
(12) Patent Application Publication
(10) Pub. No.: US 2015/0178840 A1
(43) Pub. Date: Jun. 25, 2015

(54) SYSTEMS AND RELATED TECHNIQUES FOR FAIRNETTING AND DISTRIBUTION OF ELECTRONIC TRADES

(71) Applicant: INTEGRAL DEVELOPMENT CORP., Palo Alto, CA (US)

(72) Inventors: Michelle Yip CHEN, San Mateo, CA (US); Vikas SRIVASTAVA, Palo Alto, CA (US); Michael TESTA, Ridgewood, NJ (US)

(21) Appl. No.: 14/637,247

(22) Filed: Mar. 3, 2015

Related U.S. Application Data
(63) Continuation-in-part of application No. 13/860,999, filed on Apr. 11, 2013.
(60) Provisional application No. 61/622,845, filed on Apr. 11, 2012.

(51) Int. Cl. G06Q 40/04

(52) U.S. Cl. CPC G06Q 40/04

(57) ABSTRACT

Fairnetting and distribution of electronic trades is described, where, a computing device includes a reception module, a trade organization module, and a trade netting module. The trade organization module organizes one or more trades, received by the reception module, by currency pairs. The trade netting module generates, at a first point in time, a netting plan designed to offset a trade against at least one other trade, and estimates, for the netting plan, a first value that is proportional to an expected savings based on real-time market data and associated with executing the trades according to the netting plan versus executing the trades without the netting plan, where the first value is not exceeded by a cost of trading proportional to a change in market value of the trades between the first point in time and a time that a first trade included in the trades is executed.

### CROSS-REFERENCE TO RELATED APPLICATIONS

The present application is a continuation-in-part of U.S. patent application Ser. No. 13/860,999, filed Apr. 11, 2013, entitled “Methods and Apparatus for Facilitating Fairnetting and Distribution Currency Trades,” which claims the benefit of, U.S. Provisional Patent Application Ser. No. 61/622,845, filed Apr. 11, 2012, entitled “Methods and Apparatus for Facilitating Fairnetting and Distribution Currency Trades,” Both of these applications are hereby incorporated herein by reference.

The present application is also related to U.S. Provisional Patent Application Ser. No. 61/747,698, filed Dec. 31, 2012, entitled “Methods and Systems for Facilitating Financial Exchanges Between Liquidity Takers and Liquidity Providers” and U.S. Provisional Patent Application Ser. No. 61/799,490, filed Mar. 15, 2013, entitled “Methods and Systems for Facilitating Financial Exchanges Between Liquidity Takers and Liquidity Providers.” Both of these provisional patent applications are also hereby incorporated herein by reference.

### BACKGROUND OF THE INVENTION

1. Field of the Invention

Embodiments of the present invention relate generally to financial trading systems and, more specifically, to systems and related techniques for fair-netting and distribution of electronic trades.

2. Description of the Related Art

Currently, different types of computer-based systems exist to facilitate online foreign exchange (FX) transactions over a communications network as well as other electronic-based financial transactions. Such systems provide quotes for and execute a portfolio, or list, of trades, where the portfolio of trades include multiple currency pairs and multiple value dates, and are expressed in terms of either base or term currencies. The portfolio of trades represents trades for one or more accounts. For example, a portfolio of trades could include two trades for a first account, four trades for a second account, three trades for a third account, and one trade for a fourth account. A computer system associated with a foreign exchange could receive such a portfolio of trades and could provide a quote for each proposed trade in the portfolio. After a trader approves each quote in the portfolio, the exchange system could execute the corresponding trade. Once all trades are executed, the proceeds from each trade could be transferred to the corresponding account.

One drawback of the above approach is that each trade is executed at market rate and has an associated transaction cost. As one example, an industry-accepted definition of transaction cost could be defined as one half of the difference between the market buy rate and market sell rate multiplied by the size of the transaction, plus any commissions or fees. The difference between the market buy rate and market sell rate is also referred to herein as the bid/offer spread. Stated another way, even if one trade in the portfolio could have been offset with another trade in the same portfolio, each trade is executed separately at the market rate and, consequently, incurs a separate transaction cost. Generally, the difference between the market buy rate and market sell rate is higher as a percentage of the trade size for larger transactions. Also, larger trades have a more significant effect on the market than do smaller trades, which may result in market trades at less favorable buy rates and sell rates. Consequently, offsetting trades which results in smaller transaction size is desirable, as the reduced trade size reduces the percentage cost. In an effort to reduce the transaction costs associated with such portfolio of trades, some approaches attempt to analyze a given portfolio for potential offsetting trades, estimate how those offsetting trades are valued based on currently available market data, and then attempt to offset trades where possible. Any remaining trades that cannot be internally offset are executed individually at market rates, as described above. Finally, all residual trades are executed to account for any differences in market rates arising between the time the estimates for the offsetting trades are calculated and the time that the market trades are executed. This difference is referred to herein as an “error term.”

One major drawback of such efforts is that market rates can change significantly between the time the offsetting trades are estimated and the time the market trades are executed. Among other things, computing the offsetting trades can take a significant amount of time, particularly for large trade portfolios that include hundreds or, even thousands of trades. Consequently, a substantial amount of time may pass between computing the offsetting estimates and executing the market trades, and, within this time frame, the market rates can change. In fact, statistically-speaking, as more time that passes, the more likely market rates will change and change substantially. Such market rate changes can cause large error terms, resulting in relatively large residual trades that reduce the advantages of internally offsetting trades in the first instance. Further, the transaction costs associated with the residual trades typically increase as the error terms increase, thereby adding more cost to the efforts to reduce transaction costs described above. Further a large market movement is more likely to occur during a more time-intensive manual calculation, which could result in the realized transaction cost being multiples of the original estimates.

As the foregoing illustrates, what is needed in the art is a more effective technique for executing electronic-based transactions.

### SUMMARY OF THE INVENTION

One embodiment of the present invention sets forth a computing device that includes a processor and a memory that includes a reception module, a trade organization module, and a trade netting module. The reception module, when executed by the processor, is configured to receive trade information describing one or more trades included in a portfolio of trades that is to be executed. The trade organization module, when executed by the processor, is configured to organize the one or more trades by currency pairs. The trade netting module, when executed by the processor, is configured to generate, at a first point in time, a first netting plan that is designed to offset at least one trade included in the one or more trades organized by currency pairs against at least one other trade included in the one or more trades organized by currency pairs. The trade netting module, when executed by the processor, is further configured to estimate, for the first netting plan, a first value that is proportional to an expected savings based on real-time market data and associated with executing the portfolio of trades according to the netting plan versus executing the portfolio of trades without the netting plan, where the first value is not exceeded by a cost of trading that is proportional to a change in market value of the portfolio of trades between the first point in time and a time that a first trade included in the portfolio of trades is executed.

Other embodiments include, without limitation, a computer-readable storage medium that includes instructions that enable a processing unit to implement one or more aspects of the disclosed approaches as well as a computer-implemented method for performing one or more aspects of the disclosed approaches.

At least one advantage of the disclosed techniques is that a portfolio of trades is efficiently netted internally in order to minimize the bid/offer spread paid and the market impact, and non-netted market trades are executed quickly at market rates. Market transaction costs are thereby reduced and proceeds are fairly and efficiently distributed back to the various accounts associated with the portfolio of trades. An important and unique feature of fair netting is to net the offsetting trades at the market mid-rate rather than the executed bid or offer rate of the residual portion executed in the market. Other foreign exchange trading software nets at the market rate used for the portion executed at market. As such, the benefit of netting is disproportionately to the benefit of the smaller transaction(s) in the currency pair, effectively getting paid to trade at a beneficial rate, while the majority side of the trade benefits only by a lower bid/offer spread from a smaller market trade. In fair netting the benefits are shared equally among the trading entities. Ideally, the midrate used for netting is calculated at the exact time that all market trades are executed in order to ensure fairness across all trades. Therefore, the time interval between netting the trades at midrate and executing market trades at bid/offer rates should be within a few seconds. In addition, the estimated result of the portfolio of trades, along with estimated transaction costs, are calculated and presented to a user in a short amount of time before the market value has the opportunity to change significantly. Stated another way, the disclosed approach enables a trader to execute a portfolio of trades via a combination of internal netting and trades at market rates quickly, before the error term materially impacts the cost of cleaning up residual amounts.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a block diagram illustrating an exemplary distributed computing system configured to implement one or more aspects of the present invention;

FIG. 1B is a block diagram illustrating another exemplary distributed computing system configured to implement one or more aspects of the present invention;

FIG. 2 is a block diagram illustrating a computing system configured to implement one or more aspects of the present invention;

FIG. 3 illustrates a call flow diagram associated with a currency exchange system, according to one embodiment of the present invention;

FIG. 4 sets forth a flow diagram of method steps for executing one or more trades via an exchange system, according to one embodiment of the present invention; and

FIG. 5 sets forth a flow diagram of method steps for executing one or more trades via an exchange system, according to another embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

Fairnetting provides a trader with all necessary information in no more than a few seconds to decide exactly how to best proceed in executing a complex list of trades by calculating precise estimates of how much needs to be traded in the market and accurately forecasting expected transaction costs with real-time tradable prices. Essentially, in order for the trader to make the correct trading decisions, a system needs to use real-time market rates to make thousands of complex calculations in a short period of time. Any delay in making these calculations would lead to the trader using stale market rates and therefore results in the trader potentially making incorrect trading decisions and resulting in higher transaction costs. Given that foreign exchange markets can significantly move in a matter of seconds, the calculations need to be made within five seconds to minimize the chances of incorrect trading decisions.

The processing and execution of trades among user machines, source machines, and liquidity provider machines (LPMs), through an exchange system is accomplished through using one or more servers and over a network. As used herein, a “trade” includes, without limitation, a spot trade, a forward trade, a swap, a roll, and/or any additional types of trades that can be executed electronically known to those having ordinary skill in the art. As used in the following description, an application includes, without limitation, a software application program, as well as program segments, modules, snippets, or other sub-portions of a software application program. In particular, the present disclosure describes an exchange system and associated applications to facilitate FX transactions and other electronic-based transactions in which trades are netted, executed, and distributed in a fair manner. Participants in the FX market engage in FX transactions for various reasons, including, without limitation, security settlements, passive and/or active hedging, currency alpha, dividends, payments, and speculative trades. The participants have one or more objectives while engaging in FX transactions, including, without limitation, minimizing transaction costs, obtaining a fair deal (e.g., no disadvantage in comparison to like positioned participants), efficient and accurate processing.

The process described herein delivers efficiency, optimality, and fairness when executing a portfolio of electronic trades. Although the techniques disclosed herein are described in the context of foreign currency trades, the disclosed techniques may be employed in the context of any technically feasible form of electronic trades within the scope of the invention. The innovations described herein include an end-to-end process having a number of steps that starts and ends with the same list of trades plus executed spot and forward rates against one or more credit facilitators. This end-to-end process leverages a number of techniques that include netting of trades (netting forward trades at individual value dates, using base amounts or estimated amounts from term currencies, etc.) across the portfolio of trades, decomposing crosses, determining the amount that needs to be executed in the market, and providing optimality to the process. These techniques involve numerous complex computations. As the time to complete these complex computations increase, the risk of a large error term also increases. Therefore, the complex computations performed in association with the disclosed techniques should be performed as rapidly as feasible.

A typical portfolio of trades includes dozens, hundreds, or even thousands of trades. As a result, netting trades, decomposing crosses, and determining the value and type of market trades involves thousands of complex calculations. These calculations are performed rapidly in order to minimize the error term and the resulting deviations in realized transactions costs. In general, the error term is more likely to increase as the time to estimate the result of netting a portfolio of trades and executing non-nettable trades at market rates increases. Therefore, the shorter the time to estimate the results of netting and executing a portfolio of trades, the more likely that the error term is minimized. Because of the complexity and volume of the necessary calculations, and the volatility of market rates, the disclosed system is specifically designed to prevent high error terms from limiting the benefits of reduced transaction costs and smaller market trades resulting from internal netting. These benefits derive from at least two sources. First, the disclosed techniques serve to reduce transaction costs. By netting trades within the portfolio of trades to the extent possible, the quantity of market trades and the amount of these trades are reduced. Typically, transaction costs increase with both the quantity of trades and with the amount of each trade. Because the disclosed techniques serve to reduce both the quantity and the size of market trades, the disclosed techniques also reduce associated transaction costs. Second, by reducing the quantity and size of market trades, the impact on the market is also reduced, resulting in a more desirable settlement price. For example, if a large sell position is placed on the market, the large sell position would have the tendency to reduce the market price, with the effect of lowering the sell price. Conversely, if a large buy position is placed on the market, the large buy position would have the tendency to increase the market price, with the effect of raising the buy price. Therefore, reducing the market exposure of trades, by internally netting trades wherever possible, more favorable buy and sell prices are achieved. In addition, aggregating liquidity and providing price discovery on both spot and forward components ensures optimal best-execution. By reducing the time needed to perform the complex computations associated with the disclosed techniques, the resulting error term is reduced. Reducing the error term leads to a reduced quantity and size of transactions for cleaning up residual amounts resulting from the described estimation techniques. A lower quantity and size of residual trade amounts serves to further reduce both transaction costs and market impact. Lastly, using mid-rates (pre-trade) for netted amounts and proportionally allocating executed trades to the appropriate originating trade list ensures fairness.

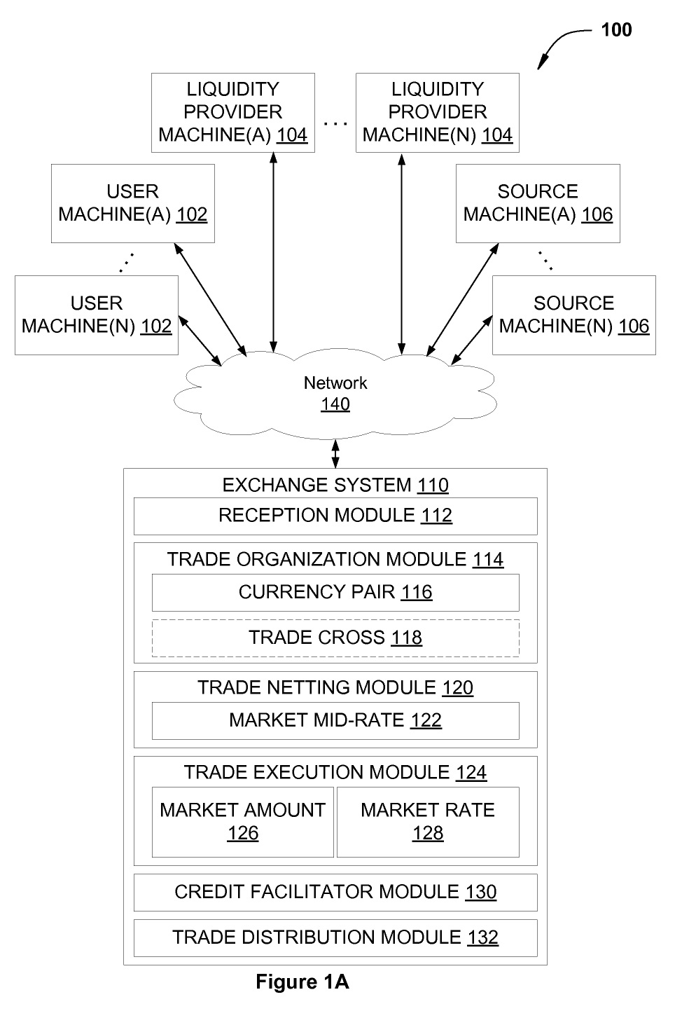

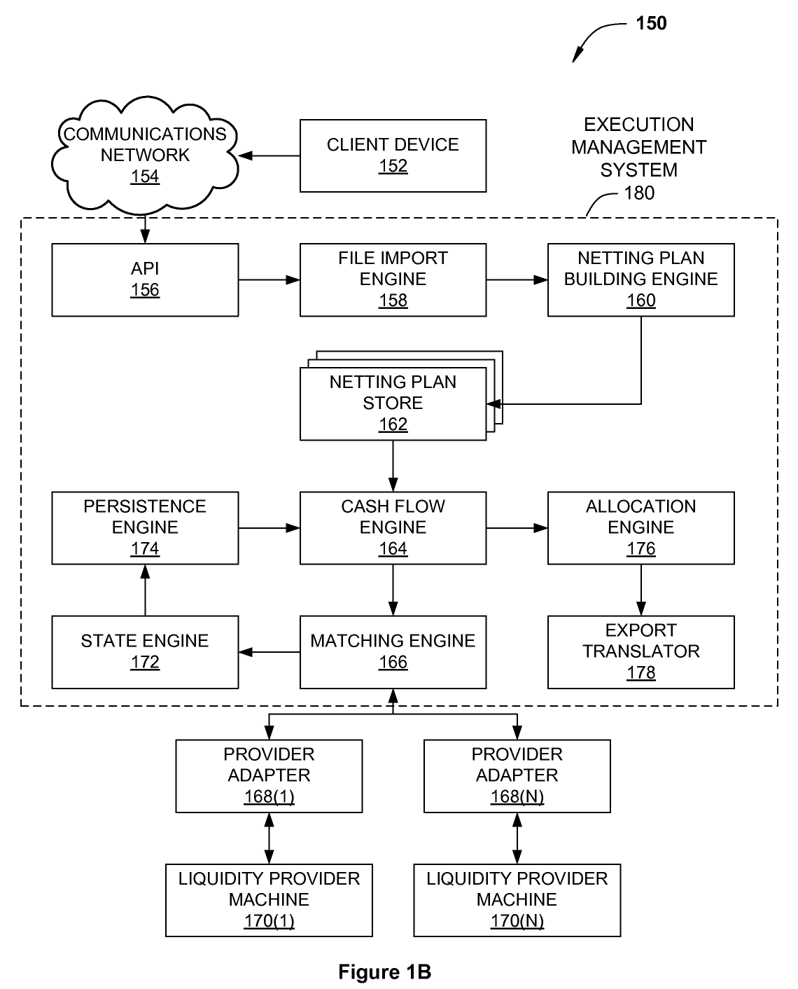

FIG. 1A is a block diagram illustrating an exemplary distributed computing system 100 configured to implement one or more aspects of the present invention. As shown, the distributed computing system 100 includes an exchange system 110, one or more user machines 102 (e.g., user machine 102(A) . . . user machine 102(N)), one or more liquidity provider machines 104 (e.g., liquidity provider machine 104(A) . . . liquidity provider machine 104(N)), and one or more source machines 106 (e.g., source machine 106(A) . . . source machine 106(N)) configured to communicate through network 140. Liquidity provider machines 104 are in communication with exchange system 110. Liquidity provider machines 104 include machines associated with a buyer or seller of financial instruments. Each liquidity provider machine 104 provides financial information to enter a trade. This financial information is hereafter be referred as the terms of the trade. In some embodiments, the source machine 106 of the terms of the trade may be a financial institution including portals or electronic order matching systems. For example, a source machine 106 could be an LPM or a credit facilitator. In some embodiments, a distributed system may include multiple source machines 106 in communication with exchange system 110.

Typically, the terms of the trade depend on the nature of the financial transaction involved. The terms of the trade include, without limitation, a currency pair, a base currency amount, a term currency amount, to buy or sell, the source of the prices, a value date, and other transaction specific details helpful for executing the transaction. In one embodiment, where the trade is a spot market transaction, the transaction specific details may include the currency pair for which the transaction may be made. The provided terms of the trade are to be stored in a database of associated with the liquidity provider machines 104.

In some embodiments, a user machine 102 may be associated with a third party, and may attempt to execute a trade. In one embodiment, the user machine 102 may specify a user-defined component based on a preference of liquidity provider machines 104. Each user machine 102 sets or assigns a user-preference status for each liquidity provider machine 104, regardless of the user-preference status assigned by another user machine 102. The terms of trade are communicated to exchange system 110 and received using trade reception module 112.

Exchange system 110 includes modules to assist with pre-trade, trade execution, and post-trade procedures. As shown, exchange system 110 includes reception module 112, trade organization module 114, trade netting module 120, trade execution module 124, credit facilitator module 130, and trade distribution module 132.

Reception module 112 is configured to receive information from various components within the currency transaction environment 100 through network 140. In one embodiment, reception module 112 may receive trade proposed rates from any of the liquidity provider machines 104 and/or source machines 106. In another embodiment, reception module 112 may receive trade requests from multiple user machines 102. Each trade request includes various terms, including, without limitation, a currency pair, a base currency amount, a term currency amount, to buy or sell, the source of the prices, a value date, and other transaction specific details helpful for executing the transaction.

Trade organization module 114 is configured to organize the received trades. In one embodiment, trade organization module 114 may organize trades by currency pair 116. In another embodiment, trade organization module 114 may organize trades by base amount requested to buy, base amount requested to sell, term amount requested to buy, term amount requested to sell. In an optional embodiment, where a trade uses an intermediary currency to facilitate the trade, trade cross values 118 may also be organized. For example, if a trade has a base currency of Australian dollars and a term currency of Japanese yen (AUDJPY), then the trade cross 118 could include conversion values into Australian dollars (AUDUSD) and Japanese yen (USDJPY).

Trade netting module 120 is configured to determine trade amounts for internal processing (e.g., among the trades included in the received list or portfolio of trade requests) rather than on the open market. In one embodiment, trade netting module 120 may net out trade amounts based on provided trade terms. In another embodiment, trade netting module 120 may estimate non-provided terms for each of the different types using a market mid-rate 122 value. In such embodiments, the market mid-rate 122 value may be derived from one or more proposed rates received from source machines 106 and/or liquidity provider machines 104. Trade netting module 120 generates at least one netted amount and at least one market amount 126 that remains after the trades have been netted internally using the estimated market mid-rate 122. Further, once a trade has been executed, trade organization module 114 and/or trade netting module 120 breaks apart the organized and netted trades so as to provide trade amounts to each of the user machines 102.

Trade execution module 124 is configured to determine a market rate 128 for a transaction involving the market amount 126. In one embodiment, if trade crosses include use of one or more intermediary currencies, then trade execution module 124 is further configured to perform one or more residual trades to clean up values remaining in the one or more intermediary currencies. In one embodiment, a market rate 128 may be obtained from a liquidity provider machine 104 and/or source machine 106 and may be based at least partially on the market amount 126 to be transacted. In one embodiment, the market rate 128 may be higher than the market mid-rate 122.

Trade distribution module 132 is configured to divide the market amount among the trade participants (e.g., user machines 102) proportionally. In one embodiment, trade distribution module 132 may divide the market amount among the trade participants using a pro rata system. In another embodiment, trade distribution module 132 may apply a weighting factor for distribution to one or more trade participants (e.g., a user with a trade request that is 90% percentage larger than other user's trade requests may receive a weighted distribution of the market amount).

In operation, reception module 112 receives electronic trades manually entered via a client device into the trade blotter and/or downloaded automatically (e.g., via a spreadsheet file). Trade organization module 114 and trade netting module 120 then nets across multiple accounts, currencies, and value dates to assist in manage risk and sets up net amounts for optimal trade processing. In one embodiment, exchange system is configured to provide pre-trade system credit or other checks to allow the user machine 102 to select only “approved” LPMs for certain trade requests on specific accounts (via streaming rates, RFQ or possibly anonymous trading). Pre-trade credit checks are used where the final FX contracts are booked as direct credit vs. bank-based liquidity provider machines 104. In an embodiment, use of a credit facilitator may alleviate the use of pre-trade credit checks since LPMs would give-up trade details to the credit facilitator which then may face the client for credit purposes. Once pre-trade procedures are completed, the trade may be executed.

Trade execution module 124 executes multiple types of trades (e.g., spot trades, forward trades, etc.). With spot trades, once trade organization module 114 and trade netting module 120 net the trades, trade execution module 124 begins executing market amounts. In operation, the trades that get netted are marked as “executed” internally using the market mid-rate 122 as determined before the market trade. That way, the netted trades are not subject to the market impact caused by the market trades. The remaining market amount 126 is executed at a market bid/offer rate (e.g., market rate 128). Thereafter, the trades are proportionally divided to the various accounts to ensure fairness of execution. In one embodiment, use of a credit facilitator may allow for consolidation of all the tickets generated during the transaction process and may deliver one clean ticket per trade to the exchange system 110. With forward trades, spot trades are rolled out to their respective value dates, without triggering an upfront cashflow. Generally, a swap combined with spot execution creates three contracts (spot, front leg of the swap, back leg of the swap). Unless the same spot rate is used for the spot and the front leg of the swap, an upfront cashflow results.

In one embodiment, exchange system 110 may further include a credit facilitator module 130 to aggregate all spot tickets into one average spot rate. Adjusted swap points may then be obtained for the original reference spot from different liquidity provider machines 104 and source machines 106 via the credit facilitator 130 to roll the position, effectively canceling the initial spot trade using the front leg of the swap and, as such, leaving an outright trade between the user machine 102 associated with a client 102 and the credit facilitator 130. The spot to forward roll may involve the same or different trading counterparties. User machines 102 may specify the spot rate resulting from the spot execution part of the process, and the counterparty who trades the forwards may quote the (adjusted) outright forward points given that spot rate.

After trades are executed, trade distribution module 132, trade organization module 114 and/or trade netting module 120 breaks down the trades into the original account details. In one embodiment, trade distribution module 132 may send trade allocations to the dealing LPM or credit facilitator 130 (if using a credit facilitator model). In one embodiment, liquidity provider machines 104 may use internal allocation technology to download trade details from the exchange system 100. Additionally or in the alternative, a number of the liquidity provider machines 104 may use a manual process to enter trade details provided by exchange system 110 into their internal booking system. In one embodiment, exchange system 110 may be used to maintain trade details for full reporting and detailed audit control.

As described herein, a system for facilitating electronic trades is disclosed in which each trading party (e.g., user machine 102) receives a fair distribution of a netted trade amount. In other words, the system allows for netting of trades to improve efficiency and reduce transactions costs while also assuring each participate in the netted trade receives a distributed amount based on the market mid-rate for netted amounts and the market rate for the market amount. By not providing all the trade participates with a distribution based on the market rate, trade participants that provided a smaller amount do not receive an unfair benefit from a better market rate obtained by participants that provided a larger amount.

FIG. 1B is a block diagram illustrating another exemplary distributed computing system 150 configured to implement one or more aspects of the present invention. As shown, the distributed computing system 150 includes a client device 152, a network 154, an execution management system 180, provider adapters 168(1)-168(N) and liquidity provider machines 170(1)-170(N).

In operation, the client device 152 communicates with the execution management system 180 over the communications network. The client device 152 transmits a portfolio of trades, such as foreign exchange trades, to the execution management system 180. The client device 152 receives quotes, in the form of one or more netting plans, from the execution management system 180, as further described herein. The client device 152 transmits a request to the execution management system 180 to execute a particular netting plan included in the one or more netting plans. The client device 152 then receives a confirmation of the execution of the netting plan from the execution management system 180 including specific details regarding settling each trade in the portfolio of trades as transmitted to the execution management system 180.

The communications network 154 facilitates communications between the client device 152 and the execution management system 180. In various embodiments, the communications network 154 may include any wired or wireless technique for facilitating communications among devices that are not directly connected.

The execution management system 180 is a hardware system that includes various engines and modules configured to perform the disclosed techniques. The execution management system 180 performs these techniques rapidly in order to provide actionable information to a trader that allows the trade to complete a portfolio of trades at reduced cost and market exposure relative to prior techniques. In order to achieve this result, the execution management system 180 performs these techniques sufficiently rapidly so that the error term does not increase to a level that substantially reduces the benefits of the disclosed techniques. The execution management system 180 receives a portfolio of trades from one or more client devices, such as client device 152. The execution management system 180 determines which liquidity provider machines 170(1)-170(N) have a credit relationship with the client device 152. The execution management system 180 determines which trades in the portfolio of trades received from the client device 152 can be netted against other trades in the portfolio of trades. In some embodiments, the execution management system 180 may net trades against each other across multiple portfolios received from multiple client devices. The execution management system 180 then creates multiple netting plans, as further described herein, and presents the netting plans to the client device 154. If the execution management system 180 receives a request from the client device 152 to execute a particular netting plane, the execution management system 180 executes market trades for non-netted trades, per the particular netting plan, executes one or more residual trades to clean up differences between estimated netted amounts and market amounts, distributes proceeds from the netted amounts and market amounts back to the original trades in the portfolio, and transmits the resulting data to the client device 154. In some embodiments, the distributed computing system 150 includes two or more execution management systems 180, each of which communicates with one or more client devices over the communications network 154. The execution management system 180 receives market data from the liquidity provider machines 170(1)-170(N). The execution management system 180 also executes market orders, according to a particular netting plan, with the liquidity provider machines 170(1)-170(N). The execution management system 180 communicates with the liquidity provider machines 170(1)-170(N) via the provider adapters 168(1)-168(N).

As shown, the execution management system 180 includes an applications protocol interface (API) 156, a file import engine 158, a netting plan building engine 160, netting plans 162, a cash flow engine 164, a matching engine 166, a state engine 172, a persistence engine 174, an allocation engine 176, and an export translator 178.

The applications protocol interface (API) 156 receives login credentials from the client device, and, upon verifying the login credentials, grants access to the execution management system 180. The API 156 then receives a portfolio of trades and translates the portfolio of trades according into an internal format that is recognizable to the execution management system 180. The API 156 transmits the translated portfolio of trades to the file import engine 158.

The file import engine 158 validates the received portfolio of trades to ensure that each trade is in the proper format and includes the essential terms needed to transact the trade. The file import engine 158 determines whether the client device 152 has credit relationships with one or more liquidity provider machines 170(1) . . . 170(N) sufficient to transact the requested portfolio of trades. After validating the portfolio of trades, the file import engine 158 translates the format of the received portfolio of trades into a format is efficiently processed by the various engines and modules within the execution management system 180. Because calculation speed is of the essence, the file import engine 158 organizes and arranges the essential terms of each trade in a format that is efficiently and rapidly accessed and processed. The file import engine 158 then transmits the portfolio to the netting plan building engine 160.

In an example where the functionality and system described herein are embodied in a trading platform (e.g., a trading platform implemented as (i) one or more software modules, (ii) one or more hardware components (e.g., ASICs and the like), or (iii) some combination of hardware and software), a first step could involve providing an interface and processing capabilities for facilitating the importation/input of trade information into the platform. By way of example and not limitation, importing could include uploading an electronic file (e.g., a .xml, spreadsheet file) comprising trade information into the platform (e.g., by way of one or more APIs, or using other techniques known to those in the art). The trade information may include information describing one or more trades to be executed using the platform, as described in additional detail below.

As used herein, “trade information” includes, without limitation, information describing (1) a trade ID (i.e., a unique identifier associated with a particular trade); (2) a CCY pair (e.g., in an embodiment where the multi-purpose platform is being used to implement foreign exchange trading); (3) a “value” date identifying the date on which the cashflow should be exchanged; (4) an indication of whether the trade is a “buy” or “sell” trade; (5) a dealt CCY value (again, in an example where the multi-purpose platform is being used to implement foreign exchange trading); (6) a deal amount describing the amount of the dealt CCY currency to be traded (again, in an example where the multi-purpose platform is being used to implement foreign exchange trading); (7) a base amount describing the amount in the base currency; (8) a term amount describing the amount in the term currency; (9) an account identifier identifying the party associated with the trade; and (10) an available credit amount identifying the amount of available credit associated with the account. While the foregoing description concentrated on “importing” the trade list information via, for example, an external file such as a spreadsheet, the instant disclosure also encompasses one or more embodiments that permit manual input of the trade information (such as the trade information described above) using techniques known in the art (e.g., a user may manually enter the trade information into the platform via, for example, user input devices and a graphical user interface).

The netting plan building engine 160 performs plan calculations for one or more netting plans, where each netting plan is designed to complete the portfolio of trades on behalf of the client device 152. The netting plan building engine 160 nets trades internally based on estimated amounts calculated from live streaming market data received from the liquidity provider machines 170(1)-170(N) and other sources, and calculations based on the live streaming market data. The netting plan building engine 160 calculates market orders, and associated transaction costs, for transactions, or portions thereof, that cannot be netted against other trades. Each netting plan built by the netting plan building engine 160 includes associated market order data needed to complete the corresponding netting plan, where the market orders are based on quotes received from one or more liquidity provider machines 170(1) . . . 170(N). As further described herein, the various netting plans include some combination of simple netting, base/term netting, and cross currency netting. The netting plan building engine 160 stores the various netting plans in the netting plan store 162.

In order to minimize the error term, the netting plan building engine 160 builds the one or more netting plans, and presents those plans to a trader, within a target amount of time. If this target amount of time is exceeded, the error term is at risk of increasing to a point that substantially reduces the benefits of the system described herein. In one example, a received portfolio could include 100 separate trades involving ten different currency pairs and four different value dates. This portfolio of trades would have to be executed rapidly enough to minimize the error term. In order to calculate three separate netting plans for the portfolio of trades would perform hundreds or even thousands of computations, for such a portfolio of trades. In order to minimize the error term, all of these computations are performed, and the final netting plans would be presented to a complex trade list in no more than five second. As an example of a recent large movement in the foreign exchange market, on the 15 of Jan. 2015, the Swiss National Bank (the Central Bank) abandoned a cap on the value Swiss Franc vs. the Euro. As a result the Swiss Franc increased in value by 30% in a few minutes. A delay in calculation in the face of such a move could result in a miscalculation of the net trade to present to the market, and indeed could turn a net buy into a net sell or vice versa, causing incorrect trades and excessive trading costs. Live streaming data and rapid calculations greatly mitigate this risk. Although the example above is described in the context of 100 separate trades involving ten different currency pairs and four different value dates, the quantity of trades, currency pairs, and value dates may be higher or lower, within the scope of this disclosure.

The netting plan building engine 160 provides an interface and processing capabilities for the selection of a netting plan. “Netting” refers to offsetting of buys and sells of like instruments against each other to reduce the market amount of trades. Appurtenant to the step of providing an interface for the selection of a particular netting plan from among a plurality of different netting plans are the designs of the respective netting plan themselves.

In an embodiment, a first selectable netting plan that may be provided via the platform described herein is a “simple netting” plan. When a user of the platform selects the simple netting plan option, the platform is operative to generate a transactional cost assessment describing the transactional costs associated with executing the portfolio of trades at issue utilizing the simple netting plan. Executing trades under the simple netting plan described herein involves netting all buy base vs. sell base trades, and netting all buy term vs. sell term trades. A user may settle on the simple netting plan for executing the trades (i.e., select the simple netting plan as the plan that will be used for executing the portfolio of trades) if doing so is desirable, or, alternatively, may select one of the other netting plans described below.

In an embodiment, a second selectable netting plan that may be provided via the platform described herein is a “base/term netting” plan. As with the simple netting plan described above, when a user of the platform selects the base/term netting plan option, the platform is operative to generate a transactional cost assessment describing the transactional costs associated with executing the portfolio of trades at issue utilizing the base/term netting plan. Executing trades under the base/term netting plan described herein involves netting a total base amount (the aggregation of all of the base amounts for each respective trade in the portfolio imported/input into the platform) vs. the estimated base value of the trade specified in term currency.

In an embodiment, a third selectable netting plan that may be provided via the platform described herein is a “base/term +cross CCY netting” plan. As with the two netting plans described above, when a user of the platform selects the base/term+cross CCY netting plan option, the platform is operative to generate a transactional cost assessment describing the transactional costs associated with executing the portfolio of trades at issue utilizing the base/term+cross CCY netting plan. Executing trades under the base/term+cross CCY netting plan described herein involves splitting any crosses (i.e., “cross currencies,” as that term is understood in the art) into an intermediary currency, also referred to herein as a vehicle currency, such as USD legs, and then netting the total base vs. the total term (in base equivalent units). In one embodiment, each trade in the portfolio of trades may be evaluated against every potential vehicle currency, and the overall transaction cost associated with each potential vehicle currency may be calculated. In such an embodiment, the vehicle currency for a particular trade in the portfolio of trades is that vehicle currency that yields the lowest overall transaction cost for the particular trade.

Thus, a user of the platform described herein may obtain a transactional costs assessment for executing a portfolio of trades under several different netting plans (e.g., one or more of the netting plans described above) prior to actually executing any trades. In this manner, a user may choose the optimal netting plan for their particular needs based in part on the transactional cost assessment that is generated by the platform. Further still, the exemplary platform described herein also includes a “refresh” feature (implemented, for example, via a radio button or the like embedded as part of the platform). Selecting (e.g., by a user) the “refresh” option from the netting plan selection interface causes the values affecting the transactional cost assessment to be updated to reflect the most up-to-date market rates available. For example, selecting the refresh option could cause the platform to obtain the most up-to-date (i.e., “real-time”) bid and offer rates. In this manner, a user may always compute estimated the transactional costs associated with the various netting plans using the most accurate, timely information available.

The netting plan store 162 is a memory or other storage device that stores the various netting plans calculated by the netting plan building engine 160.

After the client device selects a particular netting plan for execution, the cash flow engine 164 tracks which orders have been executed, which remaining orders still need to be executed, and current cash flows resulting from executed orders. After executing market orders, the cash flow engine 164 calculates residual orders needed to clean up any remaining orders, such that the final cash flow for the portfolio of trades is reduced to zero.

The matching engine 166 receives placed orders from the cash flow engine 164 based on the market orders associated with the selected netting plan. The matching order transmits placed orders to one or more corresponding liquidity provider machines 170(1) . . . 170(N). After a market order is executed, the matching engine 166 receives confirmation from the liquidity provider machine 170 that executed the order. The matching engine 166 then transmits the result of the executed order to the state engine 172.

The matching engine 166 provides an interface and processing capabilities for netting all or some of the forwards included as part of the portfolio of trades imported/input into the platform. Specifically, “netting forwards” may include taking trade mid-rate for each value date generated by the platform and assigning them to netted trades (without executing the trades in the market). An additional step may include further netting the spot component of the trades across value dates.

The matching engine 166 further provides an interface and processing capabilities for executing spot trades using at least one of the selected netting plans described above. In order to ensure that the spot trades are executed using the most up-to-date rates, in one example, a “refresh and execute” feature (implemented, for example, via a radio button or the like embedded as part of the platform) may be provided (e.g., by itself, or in addition to the “refresh” feature described above). The “refresh and execute” feature is operative to update the rates to the most up-to-date rates, and then facilitate execution of the trades.

In one example, if pre-trade mid-rate netting is configured, then a market mid rate could be calculated at the start of execution for netted amounts; otherwise, the market bid or offer rate will be used as the executed rate for the netted amounts. Once the spot trades are executed, the platform interface may be updated to populate an “executed spot rate” column, where each row in the column is associated with each of the one or more spot trades that were executed. The executed spot rate values populating this column reflect the actual spot rates at which the respective trades were executed.

The matching engine 166 further provides an interface and processing capabilities for rolling forwards. As known in the art, “rolling a forward” refers to the practice of extending the value date of a trade to a date in the future. One exemplary method of rolling a spot trade to a future value date is to enter into a swap where the front leg of the swap will completely cancel out the original spot trade, leaving the far leg of the swap as the outright. In order to avoid any cashflow differences on the spot date, it is necessary to ensure that the front leg of the swap has a spot rate that is identical to the original spot trade (fixed spot roll). In this exemplary step, the platform interface may display market forward amounts for fixed spot roll (FSR) function. The platform interface may also include a “roll” feature (implemented, for example, via a radio button or the like embedded as part of the platform). Selecting the roll feature via the interface causes the platform to generate a fixed spot roll request to providers.

Continuing with this step, a FSR may be executed for each currency pair (in an example where the platform is a foreign exchange platform) by value date. Adjusted forward points may be calculated and displayed via the interface, and “far rate” (rate on the far leg of the swap) may also be calculated and displayed via the interface.

The FSR is priced according to one or more of the following techniques. In a first technique, the matching engine 166 causes one or more liquidity provider machines 170 to receive a request to provide a price for the FSR. One or more of these liquidity provider machines 170 respond with a price quote associated with the FSR. In a second technique, one or more liquidity provider machines 170 accept a pre-specified near rate from the matching engine 166 with an associated RFS swap request. One or more of these liquidity provider machines 170 respond with adjusted forward points accordingly. In a third technique, one or more liquidity provider machines 170 upload a forward curve via either a manual or an automatic process. The matching engine 166 adjusts the forward points on the uploaded forward curve to accommodate the near rate change. With this technique, the one or more liquidity provider machines 170 can set rules and thresholds (e.g., spot rate movement, notional amount, and tenor) as to when to turn the FSR into a manual dealing mode. In a fourth technique, one or more liquidity provider machines 170 receive and respond to a standard RFS request. The matching engine 166 adjusts the forward points on the response to the RFS request in order to accommodate the near rate change. The corresponding liquidity provider machines 170 manage the cashflow differences between the two near rates. With this technique, the corresponding liquidity provider machines 170 cover the RFS in the market.

The matching engine 166 further provides an interface and processing capabilities for performing “true-up.” As known in the art, performing a “true-up” refers to the process whereby a series of trades are executed to ensure that the proper amount is executed as per the request. This is necessary due to the fact that an estimated amount may have been calculated based on the netting plan selected, and that estimated amount could turn out to be slightly different from the requested amount. In order to provide for the “true-up” functionality, in this example, the platform interface could include a “true-up” feature (implemented, for example, via a radio button or the like embedded as part of the platform). Selecting the true-up feature will cause the platform to perform true-up operations, as described above, on some or all of the executed trades.

Respective columns on the platform interface could also be provided to indicate, for example, (1) what the true-up amount was for each respective trade that required a true-up, (2) the true-up rate that was used for each respective trade that required a true-up, and (3) a status column populated with values identifying whether or not each trade was fully filled following the true-up operation.

Similar to the true-up functionality described above, in one example, the matching engine 166 further provides an interface and processing capabilities for performing a true-up operation on cross currency pairs. Specifically, any and/or all required cross currency true-up trades are calculated and executed via the platform to ensure that no vehicle CCY balances remain from splitting crosses and estimating base equivalents.

Furthermore, while the previous two steps discussed performing “true up base/term” and “true up cross currency,” respectively, those having ordinary skill in the art will appreciate that other, functionally equivalent, techniques may also be suitably employed for the purpose of resolving residual amounts generated as a result of using estimates in the netting step.

The state engine 172 receives confirmed market orders from the matching engine 166. The state engine 172 keeps track of the current state of the portfolio of trades, including which market trades have been executed and which remain to be executed. After updating the state of the portfolio, resulting from one or more executed market orders, the state engine 172 transmits the updated state to the persistence engine 174.

The persistence engine 174 ensures that the current state of the portfolio of trades remains in the netting plan store 162 until the portfolio of trades has completely executed. If a communications session between the execution management system 180 and the client device 162 is interrupted during the process of executing orders pursuant to a netting plan, the persistence engine 174 restores the state of the portfolio that existed just prior to the loss of communication. In this way, the persistence engine ensures that a portfolio of trades completes, even if communications are interrupted. The persistence engine 174 transmits the restored state to the cash flow engine 164. If there is no loss in communications, the persistence engine 174 passes the current state of the portfolio from the state engine 172 to the cash flow engine 164. The cash flow engine 164, in turn, updates the current cash flow based on the processed market orders.

The allocation engine 176 receives the results of executing the netting plan, including spot orders, forward spot rolls, and residual orders, from the cash flow engine 164. The allocation engine then allocates each of the executed orders and the netted orders back to each of the original trades in the portfolio of trades. The allocation engine 176 confirms that the cash flow resulting from execution is equal to zero. The allocation engine 176 essentially cancels each executed market order and recreates new orders, where each new order is associated with an original trade in the portfolio. In this way, each trade in the original portfolio is associated with one or more allocated orders that completes the original trade. The allocated orders fairly and efficiently completes the original trade without generating cash flow. The allocation engine 176 transmits the allocated orders, and the corresponding trades from the portfolio of trades, to the export translator 178.

The export translator 178 receives allocated orders, and the corresponding trades from the executed portfolio of trades, from the allocation engine 176. The export translator 178 then translates this information from the internal trade portfolio format into a format that is recognizable by the client device 152. As described herein, the internal format used to store the portfolio of trades provides for efficient and rapid access to the various trade terms by the various engines and modules included in the execution management system 180. However, this format is typically unsuitable for access by the client device 152. Therefore, the export translator 178 transforms data for the executed portfolio of trades into a format that is accessible by the client device 152. The execution management system 180 transmits this translated data to the client device 152 upon request.

The export translator 178 provides an interface and processing capabilities for exporting executed trade information. As used herein, “executed trade information” may include all of the types of information disclosed above with regard to “trade information,” as well as additional information associated with each respective trade post-execution. For example, this additional information could include a listing of each of the following values for each trade: (1) spot rate, (2) forward points, and (3) all-in rate. In one example, the portfolio of executed trades could be re-organized for display within the platform interface based upon an average executed spot rate for market, netted, and residual portions of a given trade, whereby the netted amounts may be netted at either pre-trade mid rates or bid or offer rates, as described above. Further still, the information (including, without limitation, the executed trade information) displayed as part of the platform interface may be delivered (e.g., exported) to a user in an accessible file format, such as a csv file format, or any other suitable file format known to those having ordinary skill in the art.

The provider adapters 168(1)-168(N) facilitate communications between the execution management system 180 and the liquidity provider machines 170(1)-170(N). In particular, the provider adapters 168(1)-168(N) translate data formats utilized by corresponding liquidity provider machines 170(1)-170(N) into a format that is recognizable by the execution management system 180. As a result, the execution management system 180 exchanges data with the liquidity provider machines 170(1)-170(N) using a single API, and each provider adapters 168(1)-168(N) translates information exchanged between the execution management system 180 and the corresponding provider adapter 168(1)-168(N).

The liquidity provider machines 170(1)-170(N) provide FX market data and FX trade quote information and transmit the market data and trade quote information to the execution management system 180. Upon receiving a request to execute one or more market trades from the execution management system 180, the liquidity provider machines 170(1)-170(N) execute the received market trades and transmits a confirmation to the execution management system 180, along with transaction details related to the executed market trades. Although the liquidity provider machines 170(1)-170(N) are shown as being directly connected to the execution management system 180 via the provider adapters 168(1)-168(N), the liquidity provider machines 170(1)-170(N) may communicate with the execution management system 180 over a network, such as communications network 154.

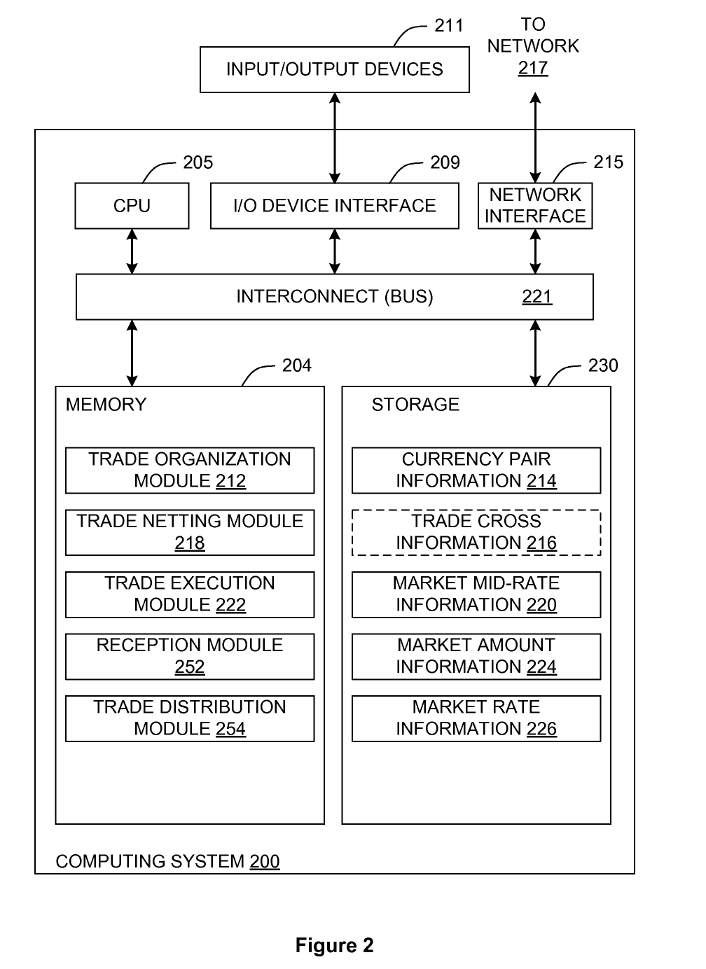

FIG. 2 is a block diagram illustrating a computing system 200 configured to implement one or more aspects of the present invention. In one embodiment, the computing system 200 may be all or part of the distributed computing system 100 depicted in FIG. 1A or all or part of the distributed computing system 150 depicted in FIG. 1B. The computing system 200 may include at least one of any type of hardware, server, personal computer, mini-computer, mainframe computer, or any computing device either special purpose or general computing device. Further, the modules and applications described herein as being operated on or executed by computing system 200 may be executed entirely on a single device, as shown in FIG. 2, or, alternatively, in other embodiments, separate servers, databases or computer devices may work in concert to provide data in usable formats to parties, and/or to provide a separate layer of control in the data flow between devices (e.g., user machines 102, liquidity provider machines 104, and source machines 106) and the modules and applications executed by computing system 200.

As shown, the computing system 200 includes, without limitation, a central processing unit (CPU) 205, a network interface 215 communicatively coupled to a network 217, a memory 204, and storage 230, each connected to a bus 221. The computing system 200 may also include an input/output (I/O) device interface 209 connecting input output (I/O) devices 211 (e.g., keyboard, display and mouse devices) to the computing system 200. Further, in context of this disclosure, the computing elements shown in computing system 200 may correspond to a physical computing system (e.g., a system in a data center) or may be a virtual computing instance executing within a computing cloud.

The CPU 205 retrieves and executes programming instructions stored in the memory 204 as well as stores and retrieves application data residing in the memory 204. The interconnect 221 is used to transmit programming instructions and application data between the CPU 205, I/O device interface 209, storage 230, network interface 215, and memory 204. Note, CPU 205 is included to be representative of a single CPU, multiple CPUs, a single CPU having multiple processing cores, and the like. And the memory 704 is generally included to be representative of a random access memory. The storage 230 may be a disk drive storage device. Although shown as a single unit, the storage 230 may be a combination of fixed and/or removable storage devices, such as fixed disc drives, removable memory cards, optical storage, network attached storage (NAS), or a storage area-network (SAN).

The computing system 200 includes memory 204, which may comprise volatile and nonvolatile memory such as read-only and/or random-access memory (ROM and RAM), EPROM, EEPROM, flash cards, or any memory common to computer platforms. Further, memory 204 may include one or more flash memory cells, or may be any secondary or tertiary storage device, such as magnetic media, optical media, tape, or soft or hard disk. Illustratively, the memory 204 includes a trade organization module 212, a trade netting module 218, a trade execution module 222, a reception module 252, and a trade distribution module 254. Illustratively, the storage 230 includes currency pair information 214, optional trade cross information 216, market mid-rate information 220, market amount information 224, and market rate information 226.

Trade organization module 212 is configured to organize the received trades. In one embodiment, trade organization module 212 may organize trades via the currency pair information 214. In another embodiment, trade organization module 212 may organize trades by base amount requested to buy, base amount requested to sell, term amount requested to buy, term amount requested to sell. In an optional embodiment, where a trade uses an intermediary currency to facilitate the trade, trade cross value information 216 may also be organized. For example, if a trade has a base currency of Australian dollars and a term currency of Japanese yen (AUDJPY), then the trade cross information 216 could include conversion values to Australian dollars (AUDUSD) and Japanese yen (USDJPY).

Trade netting module 218 is configured to determine trade amounts that may be processed internally (e.g., between the received trade requests). In one embodiment, trade netting module 218 may net out trade amounts based on provided trade terms. In another embodiment, trade netting module 218 may estimate non-provided terms for each of the different types using a market mid-rate value included in the market mid-rate information 220. In such embodiments, the market mid-rate value may be derived from one or more proposed rates received from source machines 106 and/or liquidity provider machines 104. Trade netting module 218 may result in a netted amount and a market amount included in the market amount information 224 that remains after the trades have been netted internally using the estimated values and market mid-rate. Further, once a trade has been executed, trade organization module 212 and/or trade netting module 218 may break apart the organized and netted trades so as to provide trade amounts to each of the user machines 102.

Trade execution module 222 is configured to determine a market rate included in the market rate information 226 for a transaction involving the market amount. In one embodiment, if trade crosses include use of one or more intermediary currencies, then trade execution module 222 is further configured to perform one or more residual trades to clean up values remaining in the one or more intermediary currencies. In one embodiment, a market rate may be obtained from a liquidity provider machine 104 and/or source machine 106 and may be based at least partially on the market amount to be transacted. In one embodiment, the market rate may be higher than the market mid-rate.

Reception module 252 is configured to receive information from various components within the currency transaction environment through network 217. In one embodiment, reception module 252 may receive trade proposed rates from any of the liquidity provider machines 104 and/or source machines 106. In another embodiment, reception module 252 may receive trade requests from multiple user machines 102. Each trade request may include various terms including, without limitation, a currency pair, a base currency amount, a term currency amount, to buy or sell, the source of the prices, a value date, and other transaction specific details helpful for executing the transaction.

Trade distribution module 254 is configured to divide the market amount and netted amount among the trade participants (e.g., user machines 102) proportionally. In one embodiment, trade distribution module 254 may divide the market amount among the trade participants using a pro rata system.

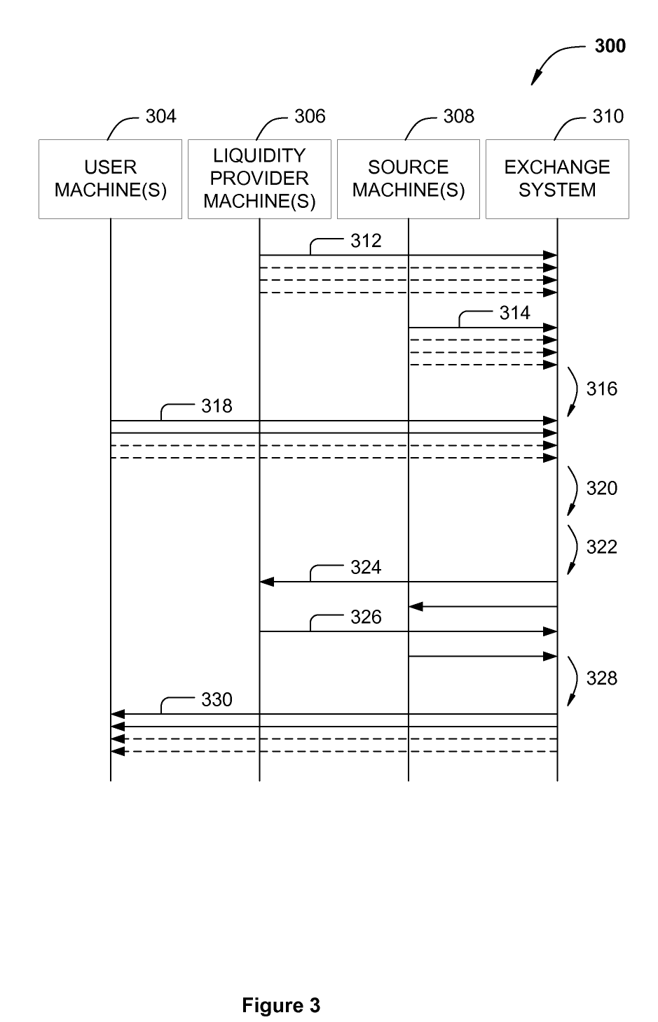

FIG. 3 illustrates a call flow diagram associated with a currency exchange system, according to one embodiment of the present invention. With reference to FIG. 3, operation of the subject matter depicted in FIGS. 1A-1B in the form of a message sequence diagram is illustrated. Specifically, with reference to FIG. 3, a currency exchange environment 300 in which interactions between a user machine 304 and an exchange system 310 is illustrated. Further, with reference to FIG. 3, interactions between at least one of liquidity provider machines 306 or source machines 308 (e.g., credit facilitators), and the exchange system 310 are illustrated.

At 312 and 314, at least one liquidity provider machine 306 provides a proposed rate of exchange between a currency pair. As shown in FIG. 3, the liquidity provider machine 306 provides multiple proposed rates and/or each of the multiple liquidity provider machines 306 provides proposed rates. At 316, exchange system 310 processes the received rate proposals and generate one or more market mid-rate values. At 318, at least one user machine 304 transmits trade requests to exchange system 310. In one embodiment, each trade request may include various terms, including, without limitation, a currency pair, a base currency amount, a term currency amount, to buy or sell, the source of the prices, a value date, and other transaction specific details helpful for executing the transaction.

At 320, exchange system 310 organizes the received trade requests into different trade types and aggregate the currency pair trades. As used herein, trade types include, without limitation, requests to buy and/or sell at values provided in a base and/or term currency. Exchange system 310 aggregates the received trades into currency pairs and estimates non-provided values associated with the various received trade requests using the market mid-rate value. For example, where a trade request includes a sell request in a term currency, the market mid-rate value could be used to estimate a base currency value for the requested trade. At 322, exchange system 310 nets out values internally to determine a market amount to be transacted with at least one of the liquidity provider machines 306 or a source machine 308. For example, a first received trade request could be to buy 2 million United States dollars against Australian dollars and a second trade request could be to buy 1 million Australian dollars against United States dollars. The internal netting of the first trade and second trade would result in a market amount to complete the transactions.

At 324 and/or 326, exchange system 310 execute the market amount at market rates agreeable upon for the one or more transactions. At 328, exchange system 310 divides the market amount among the trade requests from user machines 304 proportionally. In one embodiment, exchange system 310 may further break down the aggregated trades and proportionally distribute the netted amount based on the market mid-rate and the market amount based on the market rate. At 330, the exchange system 310 transmits the trade values back to the user machines 304 that provided the trade requests.

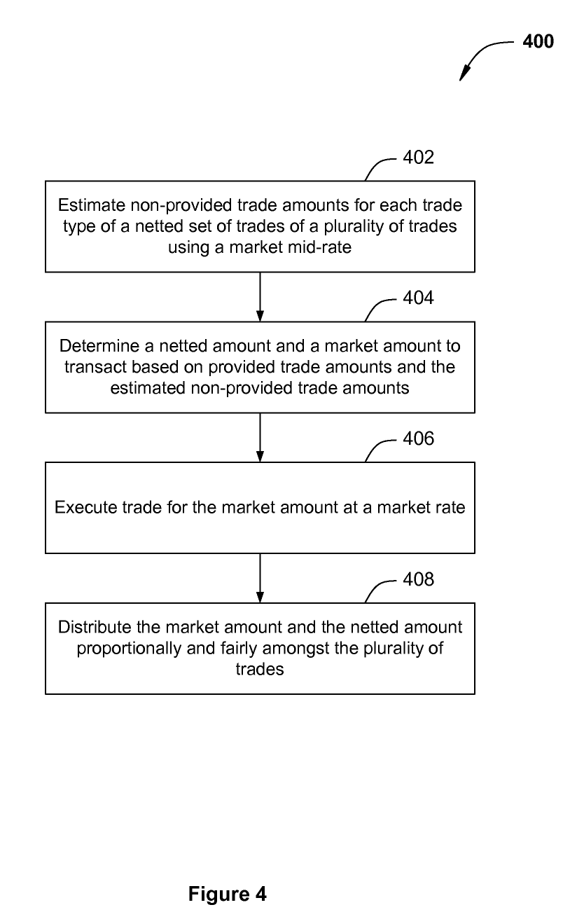

FIG. 4 sets forth a flow diagram of method steps for executing one or more trades via an exchange system, according to one embodiment of the present invention. Although the method steps are described in conjunction with the systems of FIGS. 1A-1B and 2, persons of ordinary skill in the art will understand that any system configured to perform the method steps, in any order, is within the scope of the present disclosure.

As shown, a method 400 begins at step 402, where the execution management system 180 estimates non-provided trade information for each trade type of aggregated sets of trades of a plurality of trades using a market mid-rate. The market mid-rate for each trade type of the aggregated sets of trades is estimated based on a variety of factors including, without limitation, market data received from the liquidity provider machines 170(1) . . . 170(N), market data from news and quoting services, and market data from other information sources. In one embodiment, the exchange system may receive the plurality of trades from one or more users, where each trade of the plurality of trades includes trade information. In such embodiments, information may include at least one of a currency pair, a base currency amount, a term currency amount, to buy or sell, a value date, etc. In one embodiment, the market mid-rate may be determined from receiving one or more proposed transaction rates from one or more market entities, and determining the market mid-rate based on at least one of the one or more received proposed transaction rates. In such embodiments, market entities may be approved prior to participation in any trading. In another embodiment, the aggregated sets of trades may include trade crosses including at least one intermediary currency, and the exchange system may further estimate non-provided trade information for each of the at least one intermediary currency.

At step 404, the execution management system 180 determines one or more netted amounts and one or more market amounts to transact based on received trade information and the estimated non-provided trade information. The combination of steps 402 and 404 are performed rapidly and efficiently regardless of the quantity of trades in the portfolio of trades, so that the error term is minimized. Stated another way, the execution management system 180 completes steps 402 and 404 before the error term has the opportunity to increase to a point that substantially reduces or eliminates the benefits of the disclosed techniques.

At step 406, the execution management system 180 executes one or more trades for the market amount at a market rate. In one embodiment, the exchange system may further execute at least one residual trade to remove any value remaining in the at least one intermediary currency. In another embodiment, at least one of the plurality of trades may include a forward trade, and the exchange system may further execute a client specified spot swap for the forward trade. In such embodiments, a market entity used to execute the trade associated with the plurality of trades may or may not be tied to which market entity that can be used for the forward trade.

At step 408, the execution management system 180 distributes the market amount and the netted amount proportionally and/or fairly among the plurality of trades. In one embodiment, the exchange system may use a pro-rata system to distribute the trades. The method 400 then terminates.

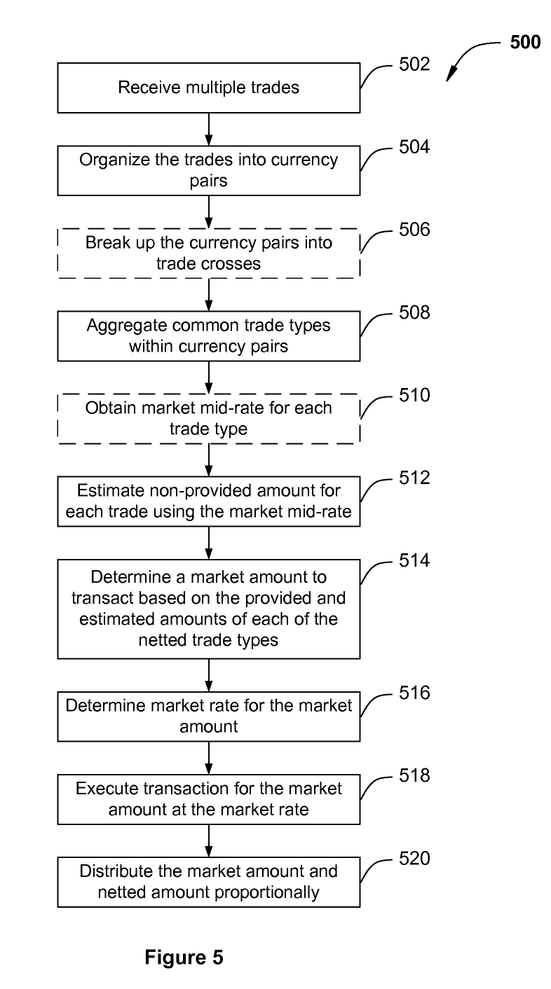

FIG. 5 sets forth a flow diagram of method steps for executing one or more trades via an exchange system, according to another embodiment of the present invention. Although the method steps are described in conjunction with the systems of FIGS. 1A-1B and 2, persons of ordinary skill in the art will understand that any system configured to perform the method steps, in any order, is within the scope of the present disclosure. In various embodiments, the method 500 described herein may be performed by an exchange system and/or one or more systems in communication with each other, either directly or over a network (e.g., network 140). In one embodiment, an exchange system such as the exchange system depicted in FIGS. 1A-1B may receive the multiple trade requests from one or more users (e.g., user machines 102).

As shown, a method 500 begins at step 502, where the execution management system 180 receives multiple trade requests. At step 504, the execution management system 180 organizes the received trade requests into currency pairs. In an optional embodiment, if the trade pairs include a need for use of an intermediary currency, then at step 506, the exchange system breaks the currency pairs up into trade crosses through these intermediary currencies. At step 508, the execution management system 180 aggregates the organized trade currency pairs.

In an optional embodiment, at step 510, the execution management system 180 may obtain one or more market mid-rates for transactions associated with the currency pairs. In one embodiment, the exchange system may derive the one or more market mid-rates from rate proposals provided by one or more source machines 106, liquidity provider machines 104, and other machines.

At step 512, the execution management system 180 estimates values that were not included in the trade request based on the market mid-rate. For example, if a trade request includes a term amount using a term currency, then the market mid-rate could be used to estimate a base amount with a base currency. At step 514, once the non-provided terms have been estimated, the execution management system 180 internally nets out at least a portion of the trades, potentially resulting a remaining market amount left after the netting. At step 516, the execution management system 180 obtains a market rate for the proposed transaction for the market amount. The combination of steps 502 through 516 are performed rapidly and efficiently regardless of the quantity of trades in the portfolio of trades, so that the error term is minimized. Stated another way, the execution management system 180 completes steps 502 through 516 before the error term has the opportunity to increase to a point that substantially reduces or eliminates the benefits of the disclosed techniques. At step 518, the execution management system 180 may cause the execution of one or more transactions for the market amount. Where a trade involved one or more intermediary currencies, then these transactions are performed. Any residual transactions are then executed to clean up the amounts remaining in an intermediary currency. At step 520, the execution management system 180 distributes the netted amount (e.g., based on the market mid-rate) and the market amount (based on the market rate) among the parties from which the trades were received. In one embodiment, the distribution may be performed in a pro rata manner assuring fairness for all trade participants while maintaining the efficiency obtained from trade netting. The method 500 then terminates.

In one example, the functionality and system described herein could be embodied in a trading platform, such as the FX Inside™ platform offered by Applicant. Such a trading platform may be implemented via distributed computing systems 100 or 150, computing system 200, or any other suitable computing-system using techniques well-known in the art. In the discussion of such an exemplary platform as described herein, it is important to bear in mind that the specific order in which certain processing is carried out is not critical. That is to say, the instant disclosure envisions performing the processing operations described herein in any suitable order. Further still, in certain embodiments, the processing may include some, or all, of the processing operations described herein. Stated another way, the instant disclosure envisions certain embodiments where only a single step of the processing is performed, embodiments where all of the processing steps are performed, and embodiments where some, but not all, of the processing steps are performed.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., video processing and/or speech analysis applications) or related data available in the cloud.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computing device, comprising:
a processor; and
a memory that includes a reception module, a trade organization module, and a trade netting module,
wherein, when executed by the processor:
the reception module is configured to receive trade information describing one or more trades included in a portfolio of trades that is to be executed;
the trade organization module is configured to organize the one or more trades by currency pairs; and
the trade netting module is configured to:
generate, at a first point in time, a first netting plan that is designed to offset at least one trade included in the one or more trades organized by currency pairs against at least one other trade included in the one or more trades organized by currency pairs, and
estimate, for the first netting plan, a first value that is proportional to an expected savings based on real-time market data and associated with executing the portfolio of trades according to the netting plan versus executing the portfolio of trades without the netting plan;
wherein the first value is not exceeded by a cost of trading that is proportional to a change in market value of the portfolio of trades between the first point in time and a time that a first trade included in the portfolio of trades is executed.

2. The computing device of claim 1, wherein, when executed by the processor, the reception module is further configured to receive a selection of the first netting plan included in the plurality of netting plans.

3. The computing device of claim 2, wherein the total estimated cost associated with executing the one or more trades according to the first netting plan is lower than the total estimated costs associated with executing the one or more trades according to a second netting plan included in the plurality of netting plans.

4. The computing device of claim 3, further comprising a trade execution module that, when executed by the processor, is configured to execute the market trade based on the first netting plan.

5. The computing device of claim 1, wherein the first netting plan included in the plurality of netting plans comprises a simple netting plan that is designed to:
net all buy base trades included in the one or more trades against all sell base trades included in the one or more trades; and
net all buy term trades included in the one or more trades against all sell term trades included in the one or more trades.

6. The computing device of claim 1, wherein the first netting plan included in the plurality of netting plans comprises a base/term netting plan that is designed to:
identify a first trade included in the one or more trades, wherein the first trade specifies a base amount expressed in a base currency of a currency pair;
identify a second trade included in the one or more trades, wherein the second trade specifies a term amount expressed in a term currency of the currency pair;
generate a third trade that includes an estimated base amount expressed in the base currency corresponding to the term amount of the second trade; and
net the first trade against the third trade.

7. The computing device of claim 1, wherein the first netting plan included in the plurality of netting plans comprises a base/term plus cross-currency netting plan that is designed to:
identify a first trade included in the one or more trades, wherein the first trade specifies a base currency and a term currency of a first currency pair;
split the first trade into a second trade for a second currency pair associated with the base currency and an intermediate currency and a third trade for a third currency pair associated with the intermediate currency and the term currency; and
net at least one of:
the second trade against a fourth trade included in the one or more trades, wherein the fourth trade corresponds to the second currency pair; and
the third trade against a fifth trade included in the one or more trades, wherein the fifth trade corresponds to the third currency pair.

8. The computing device of claim 1, wherein, when executed by the processor, the trade netting module is further configured to:
obtain current market rates associated with the one or more trades as the market rates change; and
update the total estimated cost associated with executing the one or more trades for each netting plan based on based on the current market rates.
